(19) United States
(12) Patent Application Publication
(10) Pub. No.: US 2023/0050535 A1
(43) Pub. Date: Feb. 16, 2023

(54) VOLUMETRIC VIDEO FROM AN IMAGE SOURCE

(71) Applicant: TETAVI LTD., Ramat Gan (IL)

(72) Inventors: Vsevolod KAGARLITSKY, Ramat Gan (IL); Shirley KEINAN, Tel Aviv (IL); Amir GREEN, Mitzpe Netofa (IL); Yair BARUCH, Tel Aviv (IL); Roi LEV, Brooklyn, NY (US); Michael BIRNBOIM, Holon (IL); Michael TAMIR, Tel Aviv (IL)

(21) Appl. No.: 17/569,945

(22) Filed: Jan. 6, 2022

Related U.S. Application Data
(60) Provisional application No. 63/135,765, filed on Jan. 11, 2021.

(51) Int. Cl. G06T 15/20; G06T 15/04; G06T 17/20; G06T 7/194; G06N 3/08

(52) U.S. Cl. CPC G06T 15/205; G06T 15/04; G06T 17/20; G06T 7/194; G06N 3/08

(57) ABSTRACT

A method for generating one or more 3D models of at least one living object from at least one 2D image comprising the at least one living object. The one or more 3D models can be modified and enhanced. The resulting one or more 3D models can be transformed into at least one 2D display image; the point of view of the output 2D image(s) can be different from that of the input 2D image(s).

### FIELD OF THE INVENTION

The present invention generally pertains to a system and method for generating one or more 3D models of at least one living object from at least one 2D image comprising the at least one living object. The one or more 3D models can be modified and enhanced. The resulting one or more 3D models can be transformed into at least one 2D display image; the point of view of the output 2D image(s) can be different from that of the input 2D image(s).

### BACKGROUND OF THE INVENTION

U.S. Granted Patent No. U.S. Pat. No. 8,384,714 discloses a variety of methods, devices and storage mediums for creating digital representations of figures. According to one such computer implemented method, a volumetric representation of a figure is correlated with an image of the figure. Reference points are found that are common to each of two temporally distinct images of the figure, the reference points representing movement of the figure between the two images. A volumetric deformation is applied to the digital representation of the figure as a function of the reference points and the correlation of the volumetric representation of the figure. A fine deformation is applied as a function of the coarse/volumetric deformation. Responsive to the applied deformations, an updated digital representation of the figure is generated.

However, U.S. Pat. No. 8,384,714 discloses using multiple cameras to generate the 3D (volumetric) image.

U.S. Patent Application Publication No. US2015/0178988 teaches a method for generating a realistic 3D reconstruction model for an object or being, comprising:
a) capturing a sequence of images of an object or being from a plurality of surrounding cameras;
b) generating a mesh of said an object or being from said sequence of images captured;
c) creating a texture atlas using the information obtained from said sequence of images captured of said object or being;
d) deforming said generated mesh according to higher accuracy meshes of critical areas; and
e) rigging said mesh using an articulated skeleton model and assigning bone weights to a plurality of vertices of said skeleton model; the method comprises generating said 3D reconstruction model as an articulation model further using semantic information enabling animation in a fully automatic framework.

However, US20150178988 requires a plurality of input 2D images.

U.S. Granted Patent No. U.S. Pat. No. 9,317,954 teaches techniques for facial performance capture using an adaptive model. For example, a computer-implemented method may include obtaining a three-dimensional scan of a subject and a generating customized digital model including a set of blend shapes using the three-dimensional scan, each of one or more blend shapes of the set of blend shapes representing at least a portion of a characteristic of the subject. The method may further include receiving input data of the subject, the input data including video data and depth data, tracking body deformations of the subject by fitting the input data using one or more of the blend shapes of the set, and fitting a refined linear model onto the input data using one or more adaptive principal component analysis shapes.

However, U.S. Pat. No. 9,317,954 teaches a method where the initial image(s) are 3D images.

U.S. Granted Patent No. U.S. Ser. No. 10/796,480 teaches a method of generating an image file of a personalized 3D head model of a user, the method comprising the steps of: (i) acquiring at least one 2D image of the user's face; (ii) performing automated face 2D landmark recognition based on the at least one 2D image of the user's face; (iii) providing a 3D face geometry reconstruction using a shape prior; (iv) providing texture map generation and interpolation with respect to the 3D face geometry reconstruction to generate a personalized 3D head model of the user, and (v) generating an image file of the personalized 3D head model of the user. A related system and computer program product are also provided.

However, U.S. Ser. No. 10/796,480 requires “shape priors”—predetermined ethnicity-specific face and body shapes—to convert the automatically-measured facial features into an accurate face. Furthermore, either manual intervention or multiple images are needed to generate an acceptable 3D model of the body.

It is therefore a long felt need to provide a system for generating at least one modifiable and enhanceable 3D model from a single 2D image, without manual intervention.

### SUMMARY OF THE INVENTION

It is an object of the present invention to disclose a system and method for generating at least one modifiable and enhanceable 3D model comprising at least one living object from at least one 2D image comprising the at least one living object.

### BRIEF DESCRIPTION OF THE FIGURES

In order to better understand the invention and its implementation in practice, a plurality of embodiments will now be described, by way of non-limiting example only, with reference to the accompanying drawings, wherein

FIG. 1 schematically illustrates a method of transforming an input 2D image to a 3D model and sending a compressed 3D model to an end device;

FIGS. 2A-C schematically illustrate embodiment of methods for transforming a 2D image to a 3D model; and

FIG. 3 schematically illustrates a method of transforming an input 2D image to a 3D model and sending a compressed 3D model to an end device.

### DETAILED DESCRIPTION OF THE PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for generating a modifiable and enhanceable 3D models from a 2D image

The term ‘image’ hereinafter refers to a single picture as captured by an imaging device. A view of a couple dancing, as captured from a position on a dais, constitutes a non-limiting example of an image. A view of a face, showing only the face on a black background, constitutes a non-limiting example of an image.

The term ‘a sequence of images’ hereinafter refers to more than one image, where there is a relationship between each image and the next image in the sequence. A sequence of images typically forms at least part of a video or film.

The term ‘object’ hereinafter refers to an individual item as visible in an original image.

The term ‘model’ hereinafter refers to a representation of an object as generated by software. For non-limiting example, as used herein, a person constitutes an object. The person, as captured in a video image, also constitutes an object. The person, as input into software and, therefore, manipulatable, constitutes a model. A 3D representation of the person, as output from software, also constitutes a model.

The method allows creation of a single 3D model or a sequence of 3D models (volumetric video) from any device that can take regular 2D images.

Volumetric video can generated from a video that was generated for this purpose, from an old video, from a photograph, and any combination thereof. For example, one or more 3D models can be built from a photograph of people who are now dead, or from a photograph of people as children. In another example, a 3D model, a sequence of 3D models or a volumetric video can be generated of an event, such as a concert or a historic event, caught on film. Another example can be “re-shooting” an old movie, so as to generate a volumetric video of the movie.

Method steps:
1. Obtain a single image or a sequence of images.
2. Upload the image(s) to a remote device (preferably in the cloud). This enables devices with limited computing power to run the application since the analysis is done remotely, on more powerful device(s).
3. Generate a 3D model. Possible options:
   a. Input the image(s) to a geometry neural network that outputs a 3D model and then pass the result to a neural network that generates texture for the model.
   b. Input the image(s) to a neural network that handles both generating a 3D model and generating texture for the model.
   c. In some embodiments, execute an optional step of transforming the model into a latent space representation. This can be executed before input to a geometry neural network or after output from a geometry neural network or a geometry/texture neural network.
4. In some embodiments, modifications can be made to the 3D model geometry, the texture or both, either on the 3D model or in the latent space representation. Non-limiting examples of modification are beautification, adding an accessory, enhancing a color, changing a color, changing clothing, adding clothing, changing a hairstyle, adding hair, and any combination thereof, altering a physical characteristic.
5. The 3D model, with or without enhancements or modifications, is compressed and sent to a render end device. In some embodiments, the latent space representation, with or without enhancements or modifications, can be compressed and sent to a render end device. In some embodiments, the latent space representation, with or without enhancements or modifications, is sent to a render end device without compression, since a latent space representation is already compressed.
   a. In some embodiments, the compression is done on the 3D model and the compressed 3D model is sent to the end device.
   b. hi some embodiments, the transformation from latent space representation to 3D model is done on the end device. Compression of the latent space representation, if carried out, is done before transmission to the end device.
6. On the end device, the 3D model is rendered into 2D from a virtual camera view point. The virtual camera viewpoint need not be the same as the original input viewpoint. The end device can be, for non-limiting example, a computer, a mobile phone, an augmented reality viewer, or a virtual reality (VR) viewer. The AR viewer can be a computer, a mobile phone, a heads-up display, a headset, goggles, spectacles, or any combination thereof. A VR viewer can be a phone, a headset, a helmet, goggles, spectacles, or a head-mounted display. The output on the end device can be a 2D image, a sequence of 2D images, a plurality of 2D images, a 3D model, a sequence of 3D models, and a plurality of 3D models.
7. A rendered image can be in AR or in VR. If it is VR, the image is rendered in the selected 3D environment.

An optional preprocessing stage for any of the above comprises a segmentation stage, which separates foreground from background and can, in some embodiments, separate one or more objects from the background, with the one or more objects storable and further analyzable and (if desired) manipulatable from the background and the unselected objects. The segmentation stage is implemented by means of a segmentation neural network.

Preferably either in step (3) or in step (4), the 3D model is completed b negating any portion that was invisible in the original image(s).

For embodiments that employ a latent space representation, a float vector of N numbers is used to represent the latent space. In some embodiments, N is 128, although N can be in a range from 30 to 10⁶. The geometry NN that receives the latent space vector and outputs the 3D representation is of the “implicit function” type in which it receives the latent space vector and a set of points [x, y, z] and outputs, for each point (xᵢ, yᵢ, zᵢ) a Boolean that describes whether the point is in the body or outside the body, thus generating a cloud of points that describes the 3D body.

In some embodiments, the output of the implicit function comprises, for each point (xᵢ, yᵢ, zᵢ) a color value as well as a Boolean that describes whether the point is in the body or outside the body.

In some embodiments, for each point (xᵢ, yᵢ, zᵢ) the NN returns whether the point is inside or outside the 3D model and a color value.

The color values can be, but are not limited to, CIE, RGB, YUV, HSL, HSV, CMYK, CIELUV, CIEUVW and CIELAB.

Another method is to project the input texture onto the 3D model and to use the implicit function to generate the portions of the 3D model that were invisible in the original 2D image

In some embodiments, training set(s) are used to train the geometric neural network(s) to add “accurate” texture and geometry to the 3D model(s). Since the original image(s) are in 2D, parts of the 3D model will have been invisible in the original 2D image(s) so that, by means of the training sets, the geometric neural network(s) learn how to complete the 3D model by adding to the 3D model a reasonable approximation of the missing portions. In such embodiments, a trained NN will fill in the originally invisible portion(s) with an average of the likely missing texture (and geometry) as determined from the training sets. For non-limiting example, an input image shows the front of a person wearing a basketball jersey. The back is invisible; there is no way to tell what number the person would have had on the back of the jersey. The training set would have included jersey backs with many different numbers, so that the “accurate” 3D model resulting from the averaged output would have a jersey with no number on the back. Similarly, the jersey back would be unwrinkled, since the locations of the wrinkles would be different on different jerseys.

In preferred embodiments, one or more Generative Adversarial Networks (GANs) is used to create a “realistic” model instead of an “accurate” model. Instead of, or in addition to, one or more GANs, one or more variational encoders can be used. In a GAN, two types of network are used, a “generator” and a “discriminator”. The generator creates input and feeds it to the discriminator; the discriminator decides if it the input it receives is real or not. Input the discriminator finds to be real (“realistic input”) can be fed back to the generator, which then can use the realistic input to improve later instances of input it generates.

To train the GAN, two types of input are used, “ground truth” input and generator input, where ground truth input is what an outside observer deems to be real. A 3D model of a basketball player generated from photographs of the player from a number of directions is a non-limiting example of a ground truth input. A “basketball player training set”, for non-limiting example, might comprise all of the New York Knicks players between 2000 and 2020. Another non-limiting example of a “basketball player training set” might be a random sample of all NBA players between 2000 and 2020.

Ground truth input and generator input are fed to the discriminator; the discriminator decides whether the input it received is ground truth or not. The discriminator input is checked by a trainer—was the discriminator input realistic or not. This is compared to the discriminator output, a Boolean generator input/ground truth input. Generator input that “fooled” the discriminator can then be fed back to the generator to improve its future performance. The GAN is deemed to be trained when the discriminator output is correct 50% of the time.

\In all cases, the system is configured to generate a model that is sufficiently realistic that a naïve user, one who is unfamiliar with the geometry and texture of the original object, will assume that the realistic textured 3D model or the resulting output image(s) accurately reproduce the original object.

Geometry as well as texture is generated for the portions of an object that were invisible in the original image(s). For non-limiting example, if the original object was a 2D frontal image of a person from the waist up, the output 3D model could comprise the person's legs and feet and could comprise a hairstyle that included the back of the head as well as the portions of the sides visible in the original image.

In some embodiments that employ a geometry neural network and a texture neural network, or which employ a combined geometry and texture neural network, the latent space representation is not used.

In some embodiments that employ a geometry neural network, no texture is generated and, therefore, no texture neural network is needed.

In some embodiments, the implicit function is created directly from the 2D image. In some embodiments, the implicit function is created from the latent space representation. For each point (xᵢ, yᵢ, zᵢ), the output of the neural networks is whether the point is within or outside the body, and the color associated with the point.

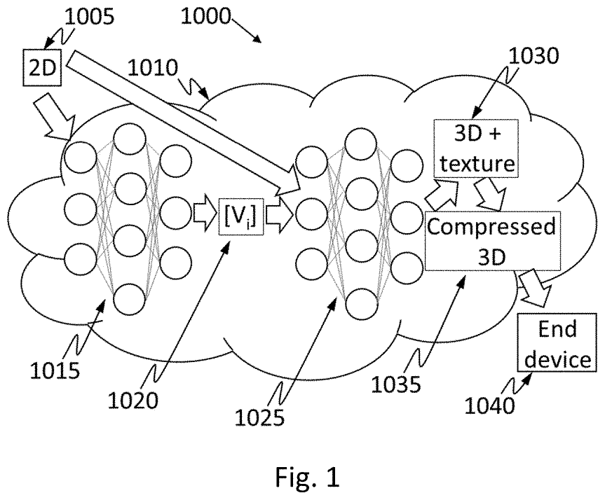

FIG. 1 illustrates an embodiment of the process (1000). The initial 2D image(s) (1005), which can be a single image, a plurality of 2D images or a sequence of 2D images, is uploaded to the cloud (1010). In some versions, the image(s) are uploaded to a neural network that generates a latent space representation (1020), with the latent space representation being passed to a neural network to generate geometry (1025). In some versions, the image(s) are uploaded directly to the neural network to generate geometry (1025). The 2D image(s) are then converted to 3D and texture is added (1030). Modifications to the 3D model(s) (or latent space representation of the images) can be made (not shown). The resulting textured 3D model(s) (or latent space representation of the images) are then compressed (1035) and sent to an end device (1040) for display. Typically, the end device will generate one or more 2D renderings of the 3D model(s) for display. However, the display can also be a 3D hologram.

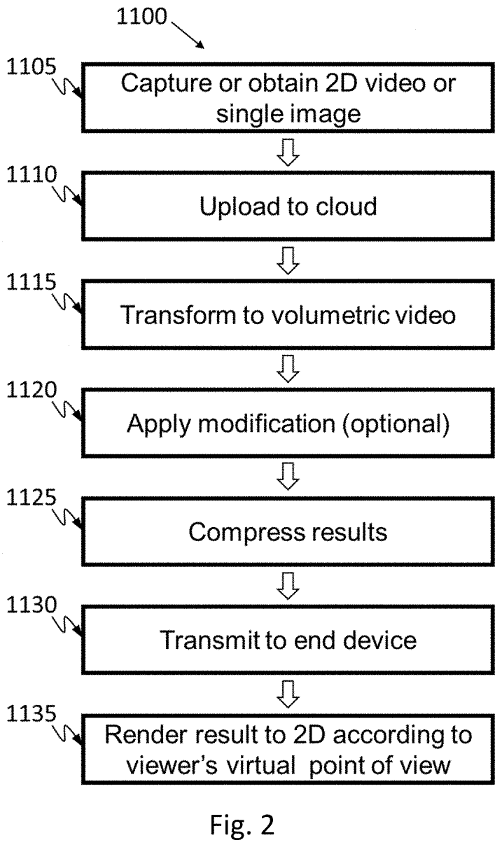

FIG. 2 illustrates a flow chart of an embodiment of the method (1100). One or more images or a sequence of images is obtained (1105). The image(s) can be new (captured by the system) or old (obtained by the system). The image(s) are uploaded to the cloud (1110) and transformed to one or more volumetric images or one or more volumetric models (1115), thereby generating a volumetric video or a volumetric model. At this point, if desired, one or more models or one or more objects in the image(s) can be modified (1120), as described above. The resulting model(s) or image(s) are then compressed (1125) and transmitted (1130) to an end device, as disclosed above, where they are rendered to one or more 2D models or 2D images or sequences of 2D models or 2D images (1135). The resulting rendered output models or image(s) can be one or more 2D images from one or more different points of view, an AR display, a YR display, and any combination thereof.

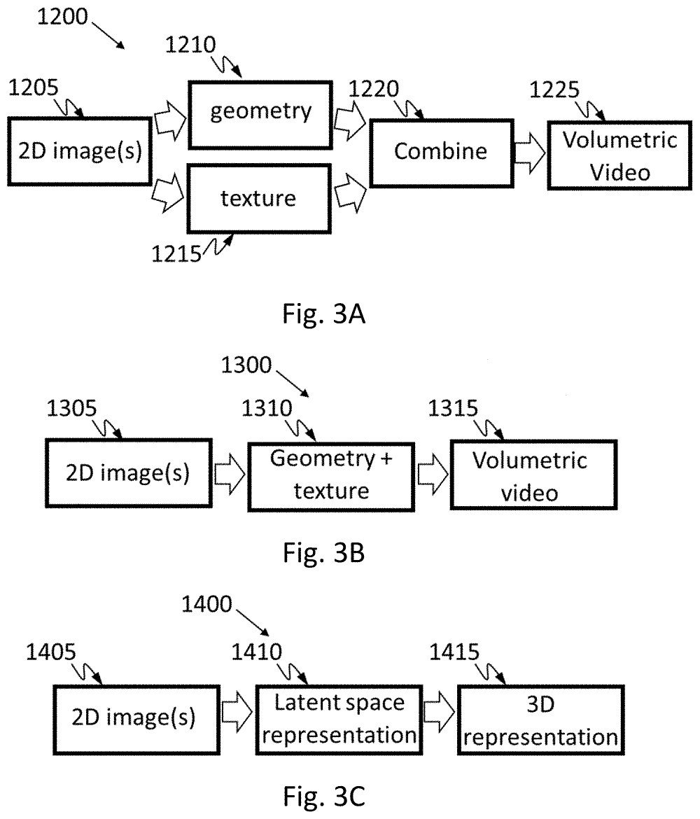

FIG. 3A-C illustrates exemplary embodiments of methods of generating a textured 3D model.

FIG. 3A schematically illustrates a method wherein different neural networks are used to generate geometry and texture (1200). The 2D image(s) (1205) are input into a geometry neural network (1210) and a texture neural network (1215). Extraction of geometry (1210) and texture (1215) can be done in parallel, as shown, or sequentially (not shown). The geometry (1210) and texture (1215) are then combined (1220) so that a 3D (volumetric) video can be generated (1225).

FIG. 3B schematically illustrates a method wherein the same neural network is used to generate both geometry and texture (1300). The 2D image(s) (1305) are input into a neural network (1305) which can determine, from the initial image(s), both geometry and texture. From the geometry and texture, a 3D (volumetric) video can be generated (1325).

FIG. 3C schematically illustrates a method wherein geometry and texture are generated via a latent space representation (1400). The 2D image(s) (1405) are converted to a latent space representation (1410) and a 3D representation (1415) is then generated. A 3D (volumetric) video can be generated (not shown) from the 3D representation (1415) in the cloud or on the end device.

### Example 1

A video has been generated of person dancing. A sequence of 3D models of the person dancing is generated from the video. The sequence of 3D models of the dancing person is then embedded inside a predefined 3D environment and published, for example, on social media. The result can be viewed in 3D, in YR or AR, with a 3D dancer in a 3D environment, or it can be viewed in 2D, from a virtual camera viewpoint, with the virtual camera viewpoint moving in a predefined manner, in a manner controlled by the user, and any combination thereof.

For non-limiting example, the original video could comprise the person doing a moonwalk. The resulting volumetric video could then be embedded in a pre-prepared 3D environment comprising a Michael Jackson thriller.

### Example 2

Wedding photos or wedding videos can e converted to a 3D hologram of the bride and groom. If this is displayed using YR, a user can be a virtual guest at the wedding.

In AR, the user can watch the bridal couple, for example, doing their wedding dance the user's living room.

### Example 3

A historical event captured video or a movie can be converted a 3D hologram. If the historical event is displayed in VR or AR, the user can “attend” a Led Zeppelin concert, “see” an opera, “watch” Kennedy's “ich bin ein Berliner” speech, or other event, all as part of the audience, or, perhaps, from the stage.

Similarly, in VR, a person can “be” a character in a movie, surrounded by the actors and sets or, in AR, have th4e movie play out in the user's home or other location.

### Example 4

Sport camera images can be converted to holograms and used for post-game analysis, for non-limiting example, who had a line of sight, where was the referee looking, was a ball in or out, did an offside occur, or did one player foul another. In addition, the question could be asked—could a referee have seen the offense from where he was standing or from where he was looking, or which referee could have (or should have) seen an offense.

Security camera images can also be converted to 3D holograms. Such holograms can be used to help identify a thief (for non-limiting example, is a suspect's body language the same as that of a thief), or to identify security failures (which security guard could have or should have seen an intruder, was the intruder hidden in a camera blind spot).

### Example 5

A user can “insert” himself into a 3D video game.

In some embodiments, the user creates at least one video in which he carries out at least one predefined game movement such as, but not limited to, a kick, a punch, running, digging climbing and descending. The video(s) are converted to 3D and inserted into a video game that uses these 3D sequences. When the user plays the game, the user will see himself as the game character, carrying out the 3D sequences on command.

In other embodiments, the user can take a single image, preferably of his entire body. The image is converted to 3D and, using automatic rigging, one or more sequences of 3D models is generated by manipulation of the single image, thereby generating at least one predefined game movement. The sequence(s) are inserted into a video game that uses these 3D sequences. When the user plays the game, the user will see himself as the game character, carrying out the 3D sequences on command.

### Example 6

A physical characteristic of the 3D model(s) can be altered. For non-limiting example, a chest size can be changed, a bust size or shape can be changed, muscularity of the model can be altered, a model's gender can be altered, an apparent age can be altered, the model can be made to look like a cartoon character, the model can be made to look like an alien, the model can be made to look like an animal, and any combination thereof.

For non-limiting example, a person's ears and eyebrows and skin color could be altered to make the person into a Vulcan, and the Vulcan inserted into a Star Trek sequence.

In another non-limiting example, a person could be videoed lifting weights and the 3D model altered twice, once to make the person very muscular, lifting the weights with ease, and once to make the person very weedy, lifting the weights only with great difficulty.

In another non-limiting example, an image of a woman in a bathing suit could be altered to have her as Twiggy (a very slender model) walking down a boardwalk with herself as Jayne Mansfield (a very curvaceous actress).

In yet another non-limiting example, a model of a woman could be altered to change her hairstyle, clothing and body shape so that she leaves an 18th Century house as a child of the court of Louis XIV, she morphs into a 14 year old Englishwoman of the Napoleonic era, then into a mid-Victorian Mexican in her late teens, then to a WWI nurse in her early 20's, a Russian “flapper” in her late 20's, a WWII US pilot in her early 30's, and so on, ending up entering a 22^{nd} Century spaceship in her early 40's as the ship's captain.

1.-46. (canceled)

47. A method for generating at least one 3D model comprising at least one living object from at least one 2D image comprising said at least one living object, comprising steps of:
obtaining at least one 2D image;
performing at least one of the following sets of steps:
set 1:
inputting the at least one 2D image into a geometry neural network, said geometry neural network generating at least one 3D model from said at least one 2D image;
inputting the at least one 3D model and said at least one 2D image into a texture neural network, said texture neural network generating at least one textured 3D model from said at least one 3D model;
set 2:
inputting the at least one 2D image into a geometry/texture neural network, said geometry/texture neural network generating at least one textured 3D model from said at least one 2D image;
set 3:
generating at least one latent space representation from said at least one 2D image;
inputting the at least one 2D image into a texture neural network and generating at least one 3D texture representation;
generating at least one 3D object from said at least one latent space representation;
combining said at least one 3D object and said at least one 3D texture representation to generate at least one textured 3D object;
set 4:
generating at least one latent space representation from said at least one 2D image;
inputting said at least one latent space representation into a geometry/texture neural network, said geometry/texture neural network generating at least one textured 3D model from said at least one latent space representation;
thereby generating said at least one textured 3D model comprising said at least one living object from said at least one 2D image.

48. The method of claim 47, wherein at least one of the following is true:
a. said method comprises steps of uploading said at least one 2D image to the cloud, performing at least one step selected from a group consisting of set 1, set 2, set 3 and set 4, and downloading said at least one textured 3D model to a render end device;
b. said method comprises a step of embedding said at least one textured 3D model into a pre-prepared environment;
c. said method comprises a step of providing at least one Generative Adversarial Network (GAN);
d. said method comprises a step of providing a segmentation stage implemented by means of a segmentation neural network;
e. said method comprises at least one of the following steps: beautifying said at least one textured 3D model, adding at least one accessory to said at least one textured 3D model, enhancing at least one color of at least one portion of said at least one textured 3D model, altering at least one color of at least one portion of said at least one textured 3D model, altering at least one portion of at least one article of clothing on said at least one textured 3D model, altering at least a portion of a hairstyle on said at least one textured 3D model, altering at least one texture on at least one portion of said at least one textured 3D model, altering at least one physical characteristic of said at least one textured 3D model;
f. said method comprises the following steps: compressing said at least one textured 3D model, thereby generating at least one compressed 3D model, inputting said at least one compressed 3D model into said render end device, and said render end device generating at least one 2D output image from said at least one compressed 3D model.

49. The method of claim 47, wherein at least one of the following is true:
a. said method comprises a step of training, as part of said at least one GAN, a member a group consisting of said geometry neural network, said texture neural network, said geometry/texture neural network and both said geometry neural network and said texture neural network; and
b. said method comprises a step of said GAN, for each portion of said at least one 3D model invisible in said at least one 2D image, generating a realistic completion of said at least one 3D model.

50. The method of claim 47, wherein said method comprises a step of separating foreground of said at least one image from background of said at least one image via said segmentation neural network; said step of said of separating said foreground of said at least one image from background comprises segmenting at least one living object from said background.

51. The method of claim 47, additionally comprising a step of generating said at least one 2D output image from a virtual camera viewpoint.

52. The method of claim 51, wherein at least one of the following is true:
a. said method comprises a step of selecting said render end device from a group consisting of a computer, a mobile phone, an artificial reality device, a virtual reality device and any combination thereof;
b. said at least one 2D output image is an artificial reality image; and
c. said at least one 2D output image is configured for generation of an image in a virtual reality environment, embedded in a predetermined 3D environment;
d. said method comprises a step of generating at least one 2D output image from said at least one 3D model.

53. The method of claim 47, wherein at least one of the following is true:
a. said method comprises a step of compressing said at least one latent space representation, thereby generating at least one compressed latent space representation, inputting said at least one latent space representation into said render end device, said render end device generating at least one 3D model from said at least one latent space representation;
b. said method comprises the following steps: inputting said at least one latent space representation into said render end device, said render end device generating at least one 3D model from said at least one latent space representation.

54. An executable package configured, when executed, to generate at least one 3D model comprising at least one living object from at least one 2D image comprising said at least one living object, comprising software configured to:
obtain at least one 2D image;
perform at least one of the following sets of steps:
set 1:
input the at least one 2D image into a geometry neural network, said geometry neural network generating at least one 3D model from said at least one 2D image;
input the at least one 3D model and said at least one 2D image into a texture neural network, said texture neural network generating at least one textured 3D model from said at least one 3D model;
set 2:
input the at least one 2D image into a geometry/texture neural network, said geometry/texture neural network generating at least one textured 3D model from said at least one 2D image;
set 3:
generate at least one latent space representation from said at least one 2D image;
input the at least one 2D image into a texture neural network and generate at least one 3D texture representation;
generate at least one 3D model from said at least one latent space representation;
combine said at least one 3D object and said at least one 3D texture representation to generate at least one textured 3D object;
set 4:
generate at least one latent space representation from said at least one 2D image;
input said at least one latent space representation into a geometry/texture neural network, said geometry/texture neural network generating at least one textured 3D model from said at least one latent space representation;
wherein said at least one textured 3D model comprising said living object is generated from said at least one 2D image.

55. The executable package of claim 54, wherein at least one of the following is true:
a. said executable package comprises software configured to execute at least one of the following functions: upload said at least one 2D image to the cloud, perform at least one step selected from a group consisting of set 1, set 2, set 3 and set 4, and download said at least one textured 3D model to a render end device;
b. said executable package comprises software configured to execute the following function: embed said at least one textured 3D model into a pre-prepared environment.
c. said software comprises at least one Generative Adversarial Network (GAN);
d. said executable package comprises software configured to provide a segmentation stage implemented by means of a segmentation neural network;
e. said executable package comprises software configured to execute at least one of the following functions: beautify said at least one textured 3D model, add at least one accessory to said at least one textured 3D model, enhance at least one color of at least one portion of said at least one textured 3D model, alter at least one color of at least one portion of said at least one textured 3D model, alter at least one portion of at least one article of clothing on said at least one textured 3D model, alter at least a portion of a hairstyle on said at least one textured 3D model, alter at least one texture on at least one portion of said at least one textured 3D model, alter at least one physical characteristic of said at least one textured 3D model;
f. said executable package comprises software configured to execute the following functions: compress said at least one textured 3D model and generate at least one compressed 3D model, input said at least one compressed 3D model into said render end device, and said render end device generates at least one 2D output image from said at least one compressed 3D model;
g. said executable package comprises software configured to execute the following functions: compress said at least one latent space representation, thereby generating at least one compressed latent space representation, input said at least one latent space representation into said render end device, said render end device generates at least one 3D model from said at least one latent space representation; and
h. said executable package comprises software configured to execute the following functions: input said at least one latent space representation into said render end device and said render end device generates at least one 3D model from said at least one compressed latent space representation.

56. The executable package of claim 55, wherein at least one of the following is true:
a. said executable package comprises software configured to execute the following function: train, as part of said at least one GAN, a member a group consisting of said geometry neural network, said texture neural network, said geometry/texture neural network and both said geometry neural network and said texture neural network; and
b. said executable package comprises software configured to execute the following function: said GAN, for each portion of said at least one 3D model invisible in said at least one 2D image, generates a realistic completion of said at least one 3D model.

57. The executable package of claim 55, wherein at least one of the following is true:
a. said executable package comprises software configured to, separate foreground of said at least one image from background of said at least one image via said segmentation neural network; and
b. said executable package comprises software configured to, in said segmentation stage, separate said at least one living object from said background.

58. The executable package of claim 57, additionally comprising software configured to, in said segmentation stage, storie at least one of said foreground and said at least one living object.

59. The executable package of claim 55, wherein said at least one 2D output image is generated from a virtual camera viewpoint.

60. The executable package of claim 59, wherein at least one of the following is true:
a. said render end device is selected from a group consisting of a computer, a mobile phone, an artificial reality device, a virtual reality device and any combination thereof;
b. said at least one 2D output image is an artificial reality image; and
c. said at least one 2D output image is configured for generation of an image in a virtual reality environment, embedded in a predetermined 3D environment.

61. The executable package of claim 55, wherein at least one of the following is true:
a. at least one 2D output image is generated from said at least one 3D model;
b. said at least one 2D output image is from a virtual camera viewpoint;
c. said render end device is selected from a group consisting of a computer, a mobile phone, an artificial reality device, a virtual reality device and any combination thereof;
d. said at least one 2D output image is an artificial reality image; and
e. said at least one 2D output image is configured for generation of an image in a virtual reality environment, embedded in a predetermined 3D environment.
